(19) United States
(12) Patent Application Publication
(10) Pub. No.: US 2007/0139530 A1
(43) Pub. Date: Jun. 21, 2007

(54) Auto-Adatpvie Frame Rate for Improved Light Sensitivity in a Video System

(75) Inventor: Glen P. Goffin, Dublin, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: GENERAL INSTRUMENT CORPORATION, Horsham, PA (US)

(21) Appl. No.: 11/555,700

(22) Filed: Nov. 2, 2006

Related U.S. Application Data
(63) Continuation of application No. 11/303,267, filed on Dec. 16, 2005.

(51) Int. Cl. H04N 5/228

(52) U.S. Cl. 348/222.1

(57) ABSTRACT

A system, method and computer readable medium are described that improve the performance of video systems. Light is shown upon a multi-region image pickup device such as a CCD or CMOS sensor. Each region generates a portion of a full frame in response to each clock signal applied to each region. At least one clock signal is proportional to a frame rate. In low-light conditions, the clock signal, and therefore the corresponding region rate, are reduced in frequency by a clock circuit so that more light is shown upon that region of the image pickup device. The clock circuit responds to a control signal from a processor that compares a representation of the image data with threshold data to determine the level of light.

### CLAIM FOR PRIORITY

This application claims priority to and is a continuation-in-part of U.S. application Ser. No. 11/303,267 filed on Dec. 16, 2005.

### BACKGROUND

Video systems capture light reflected off of desired people and objects and convert those light signals into electrical signals that can then be stored or transmitted. All of the light signals reflected off of an object in one general direction comprise an image, or an optical counterpart, of that object per unit time. Video systems capture numerous images per second. This allows for the video display system to project multiple images per second back to the user so the user observes continuous motion. While each individual image is only a snapshot of the person or object being displayed, the video display system displays more images than the human eye and brain can process every second. In this way the gaps between the individual images are never perceived by the user. Instead the user perceives continuous movement.

In many video systems, images are captured using an image pick-up device such as a charged-coupled device (CCD) or a CMOS image sensor. This device is sensitive to light and accumulates an electrical charge when light is shone upon it. The more light shone upon an image pick-up device, the more charges it accumulates.

In general, there are at least four factors that determine how many photons, which translate to a number of electrons, will be collected. One factor is the area or size of the individual sensors in the image pick-up device. The larger the individual sensors, the more photons they collect. Another factor is the density of the photons collected by the lens system that are focused onto the image pick-up device. A poor quality lens system will have a lower density of photons. In addition, the efficiency of the individual sensors and their ability to capture photons and convert those captured photons into electrons. Again, a poor quality sensor will generate fewer electrons for the photons that strike it. Finally, the amount of time a image is shone upon image pick-up device will also influence how many photons are capture and generate electrons. The first three factors are generally dictated by process technologies and cost.

The intensity of light over a given area is called luminance. The greater the luminance, the brighter the light and the more electrons will be captured by the image pick-up device for a given time period. Any image captured by an image pick-up device under low-light conditions will result in fewer electrons or charges being accumulated than under high-light conditions. These images will have lower luminance values.

Similarly, the longer light is shone upon a CCD or other image pick-up device the more electrical charge it accumulates until saturation. Thus, an image that is captured for a very short amount of time will result in fewer electrons or charges being accumulated than if the CCD or other image pick-up device is allowed to capture the image for a longer period of time.

Low-light conditions can be especially problematic in video telephony systems. Especially for capturing the light reflected from people's eyes. The eyes are shaded by the brow causing less light to reflect off of the eyes and into the video telephone. This in turn causes the eyes to become dark and distorted when the image is reconstituted for the other user. This problem is magnified when the image data pertaining to the person's eyes is compressed so that fine details, already difficult to obtain in low-light conditions, are lost. This causes the displayed eyes to be darker and more distorted. In addition, as the light diminishes, the noise in the image becomes more noticeable. This is because most video systems have an automatic gain control (AGC) that adjusts for low-light conditions. As the light decreases, the gain is increased. Unfortunately, the gain not only increases the image data, but it also increases the noise. To put it another way, the signal to noise ratio (SNR) decreases as the light decreases.

As noted earlier, video imaging requires multiple images per second to trick the eye and brain. It is therefore necessary to capture many images from the CCD array every second. That is, the charges captured by the CCD must be moved to a processor for storage or transmission quickly to allow for a new image to be captured. This process must happen several times every second.

A CCD contains thousands or millions of individual cells. Each cell collects light for a single point or pixel and converts that light into an electrical signal. A pixel is the smallest amount of light that can be captured or displayed by a video system. To capture a two-dimensional light image, the CCD cells are arranged in a two dimensional array.

A two-dimensional video image is called a frame. A frame may contain hundreds of thousands of pixels arranged in rows and columns to form the two-dimensional image. In some video systems this frame changes 30 times every second (i.e., a frame rate of 30/sec). Thus, the image pick-up device captures 30 images per second.

In understanding how a frame is collected, it is useful to first describe how a frame is displayed. In traditional cathode ray tube displays, a stream of electrons is fired at a phosphorous screen. The phosphorous lights-up upon being struck by the electrons and displays the image. This single beam of electrons is swept or scanned back and forth (horizontal) and up and down (vertical) across the phosphorous screen. The electron beam begins at the upper left corner of the screen and ends at the bottom right corner. A full frame is displayed, in non-interleaved video, when the electron beam reaches the bottom right corner of the display device.

For horizontal scanning, the electron beam begins at the left of the screen, is turned on and moved from left to right across the screen to light up a single row of pixels. Once the beam reaches the right side of the screen, the electron beam is turned off so that the electron beam can be reset at the left edge of the screen and down one row of pixels. This time that the electron beam is turned off between scanning rows of pixels is called the horizontal blanking interval.

Similarly, once the electron beam reaches the bottom, it is turned off so that it can be reset at the top edge of the screen. This time the electron beam is turned off between frames as the electron beam is reset is called the vertical blanking interval.

In image capture systems, the vertical synchronization signal generally is synchronized with when an image is captured and the horizontal synchronization signal is generally synchronized with when the image data is output from the image pick-up device.

There is a perceived quality trade-off between the frame rate and image distortion. Higher frame rates give a more natural sense of motion but this benefit can be reduced if the images displayed are overly distorted. Slower frame rates produce lower distortion images but the sense of motion is choppy or unnatural. Thus, in some video applications, a desired frame rate is used that is high enough to produce “natural” motion yet certain regions of the frame, such as around a person's eyes, are not captured properly at that desired frame rate which leaves those areas distorted when the image is displayed later.

### BRIEF DESCRIPTION OF THE DRAWINGS

FIG. 1 is an example of a charge-coupled device (CCD);

FIG. 2 is a timing diagram for operation of the CCD shown in FIG. 1;

FIG. 3 is an example of a CMOS image sensor;

FIG. 4 is a timing diagram for operation of the CMOS image sensor shown in FIG. 2;

FIG. 5 is an example of a multi-region image pick-up device;

FIG. 6 is an example of a video capture system;

FIG. 7 is a flow chart for a process of capturing images;

FIG. 8 is an example of samples of pixels from an image;

FIG. 9 is another example of a video capture system; and

FIG. 10 is an example of a video display system.

### DETAILED DESCRIPTION

As noted earlier, low-light conditions make it difficult to capture high quality images in video telephones, camera phones and other video processing systems. A system and method are described which compensate for variable light conditions by controlling the rate of select operations of the video processing device. More specifically, a system and method are described that control the clock schemes to multiple regions of an image pick-up device so that enough frames are captured to display continuous motion while also giving other regions of the image pick-up device sufficient time to capture enough light to produce lower-distortion regions of the frames.

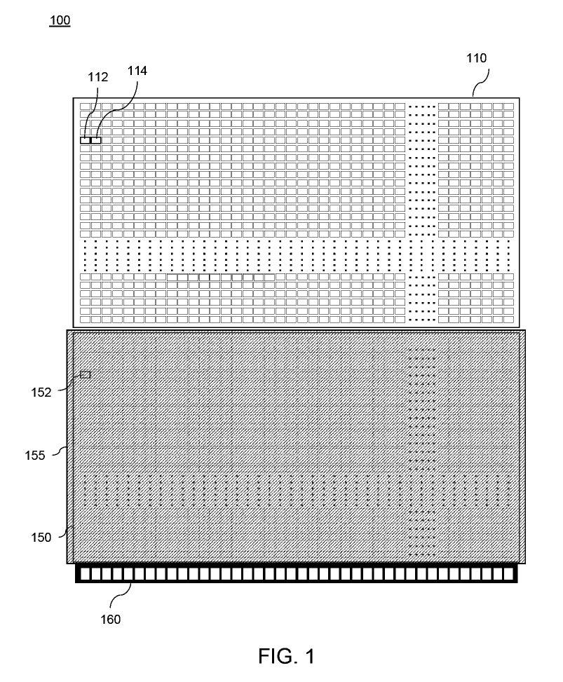

FIG. 1 is a diagram of an exemplary image pick-up device called a charge-coupled device (CCD) 100. CCD 100 is comprised of two arrays 110 and 150. Each CCD array has numerous CCD elements 112 and 152 arranged in rows and columns. Array 110 is the imaging array and array 150 is the readout array. Arrays 110 and 150 are the same size. As an example, arrays 110 and 150 may each comprise 640 CCD elements 112 and 152 in each row and 480 CCD elements 112 and 152 in each column. The total number of pixels for a frame is calculated by multiplying these numbers (640×480=307,200pixels per frame).

Arrays 110 and 150 differ structurally. For example, each CCD element 112 in array 110 has a storage element 114 adjacent to and coupled to it. These storage elements 114 receive the charge generated by each CCD element 112 in conjunction with capturing an image. Array 150 is covered by an opaque film 155. Opaque film 155 prevents the CCD elements 152 from receiving light whereas elements 112 in array 110 receive light reflected from the object or person and convert that light into electrical signals.

The operation of CCD 100 is as follows. Light is received by array 110 so as to capture an image of the desired person or object. The electrical charges stored in each CCD element 112 are then transferred to a respective storage element 114. The stored charges are then transferred serially down through array 110 into array 150. After array 150 has all the electrical charges associated with the captured image from array 110 these charges are then transferred to register 160. Register 160 then shifts each charge out of CCD 100 for further processing.

All of the above mentioned transfers (from CCD element 112 to storage element 114, through array 110 to array 150, through array 150 through to register 160 and finally shifting through register 160) occur under the control of various clock signals. In this example, CCD device 100 receives four clock signals or generates them itself with an on-chip clock circuit that receives a reference clock signal.

The first clock signal transfers the charges from CCD elements 112 to storage element 114. The second clock signal transfers all of the charges stored in storage elements 114 down into elements 152 in array 150. The third clock signal transfers the charges stored in elements 152 to register 160. The fourth clock transfers the charges from register 160 out of CCD device 100. All of these clock signals are synchronized together and with the horizontal and vertical blanking periods as will be described later.

In one example, the clocks that control transfer of charges from the CCD elements 112 to storage elements 114 and the clock that controls the transfer of charges through array 110 to array 150 are synchronized with the vertical blanking period. The clock that controls transfer of charges through array 150 to register 160 is synchronized with the horizontal blanking interval. The clock that controls the transfer of charges from register 160 out of CCD 100 is synchronized with the active line (i.e., the time when a video display device is projecting electrons onto the phosphorous screen and when a video capture device is capturing an image).

To control both image capture and display, vertical and horizontal synchronization signals are generated. In video display systems, the vertical synchronization signal controls the vertical scanning of the electron beam up and down the screen. In performing this scanning, the vertical synchronization signal has two parts. The first part is the active part where the electron beam is on and generating pixels on the display device. The second part is where the electron beam is turned off so as to return to the top-left corner of the screen. This part is called the vertical blanking interval.

Similarly, the horizontal synchronization signal controls the horizontal scanning of the electron beam left and right across the screen. This signal also has two parts. The first part is the active part where the electron beam is on and generating pixels on the display device. The second part is where the electron beam is turned off so as to return to the left edge of the screen. This part is called the horizontal blanking interval.

The length of time of the vertical blanking interval is directly related to the desired frames per second. An exemplary 30 frames per second system either captures or displays a full frame every 33.33 msec. The National Television Systems Committee (NTSC) standard requires that 8% of that time be allocated for the vertical blanking interval. Using this standard as an example, a 30 frames per second system has a vertical blanking interval of 2.66 msec and an active time of 30.66 msec to capture a single frame or image. For a 24 frames per second system, the times are 3.33 msec and 38.33 msec, respectively. Thus, a slower frame rate gives the CCD device more time to capture an image. This improves not only the overall luminance of the captured image, but also the dynamic range (i.e., the difference between the lighter and darker portions of the image).

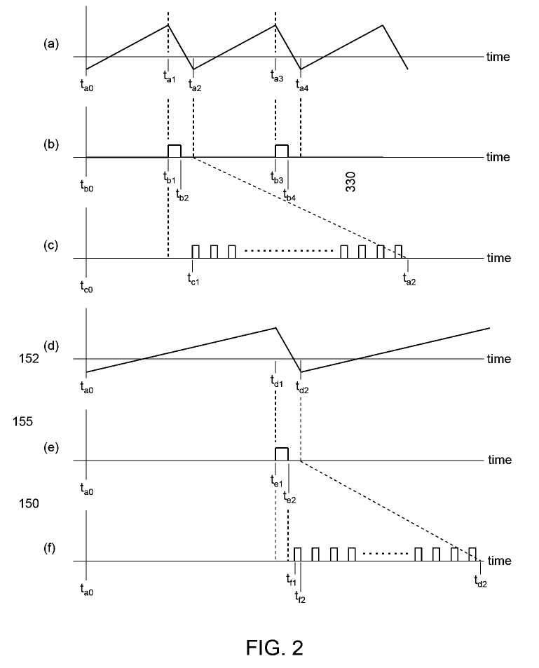

The relationships between two of those clock signals and the vertical blanking interval are shown in FIG. 2. The other two clock signals and their relationships to the horizontal blanking interval are not shown. Time lines (a), (b) and (c) in FIG. 2 show the relationship for one frame rate while time lines (d), (e) and (f) show the same relationship for a second frame rate. Time line (a) shows the vertical synchronization signal for one frame rate. From time tₐ₀ to time taₐ₁ the video system is active. In other words, it is collecting light to form the image. From time tₐ₀ to tₐ₂ the video system is inactive. During this time period the video capture system has completed capturing an image. This time period is the vertical blanking period. As shown in FIG. 2, this signal repeats such that a single frame is captured and processed during each cycle. The frequency of the vertical synchronization signal in (a) is the reciprocal of the time between tₐ₀ and tₐ₂.

As stated earlier, CCD device 100 captures the image in array 110 during the active portion of the vertical synchronization signal. After the image is captured in elements 112 of array 110, it is transferred to storage elements 114. This first clock signal, shown in (b) of FIG. 2, controls this transfer. The first clock signal is periodic with a frequency proportional to the vertical synchronization signal. In the examples shown in time lines (a) and (b) that proportion is 1:1.

The charge collected in elements 112 is transferred to storage elements 114 with the pulse shown between time t_{b1} and t_{b2}. The pulse is not transmitted until the beginning of the vertical blanking period at time tₐ₁. After this pulse is used by the CCD device 100, the elements 112 are empty while the storage devices 114 contain the charges previously accumulated by elements 112.

The next operation is to transfer the charges from storage elements 114 to elements 152 in array 150. The clock signals that perform this function are shown in (c). The scale for (c) with respect to the scales for (a) and (b) has been expanded for clarification. After time t_{b2}, the second clock signal begins at t_{c1}. This clock pulses once for every row of elements 112 in array 110. All of these pulses must be transmitted between t_{b2} and tₐ₂.

Time lines (d)-(f) show the same process but for a different frame rate. Like time line (a), an image is captured between times t_{d0} and t_{d1} in time line (d). After the image is captured, the first clock signal pulses between times tₑ₁, and tₑ₂ in time line (e). This pulse transfers the charges from elements 112 to storage element 114. After storage elements 114 receive the charges from elements 112, they are then transferred down to array 150 under the control of the second clock signal shown in timeline (f). Again, timeline (f) is shown in expanded scale with respect to timelines (d) and (e). These pulses do not begin until after time tₑ₂ and end before time t_{d2}.

A slower vertical synchronization signal (i.e., lower frequency) correlates to a lower frame rate. This means a slower vertical synchronization signal has a longer period which in turn means a longer time to capture an image. This is shown in FIG. 2 where the time between t_{d0} and t_{d1} is longer than the time between tₐ₀ and tₐ₁. As a consequence tₑ₁ is later in time than t_{b1}. This in turn gives array 110 in CCD device 100 a longer time to capture the light to form the image before the pulse signal from the first clock signal is transmitted. In low-light conditions, this longer time means more charges can be captured per frame resulting in better signal level and dynamic range of the image.

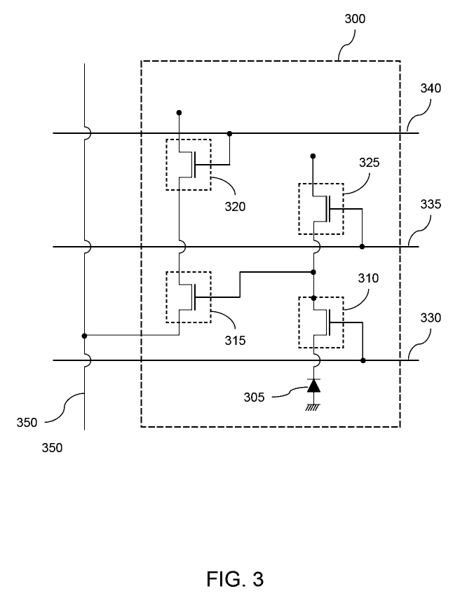

FIG. 3 is a diagram of a CMOS image sensor. Like the CCD device shown in FIG. 1, a CMOS image sensor contains thousands of individual cells. One such cell 300 is shown in FIG. 3. Cell 300 contains a photodiode 305 (or some other photo-sensitive device) that generates an electrical signal when light is shown upon it. The electrical signal generated by photodiode 305 is read by turning on read transistor 310. When read transistor 310 is turned-on, the electrical signal generated by photodiode 305 is transferred to amplifying transistor 315. Amplifying transistor 315 boosts the electrical signal received via read transistor 310. Address transistor 320 is also turned on when data is being read out of cell 300. After the data has been read and amplified, the cell 300 is reset by reset transistor 325. In some implementations of a CMOS image sensor, a shift register, like shift register 160 of FIG. 1, is coupled to output lines 350.

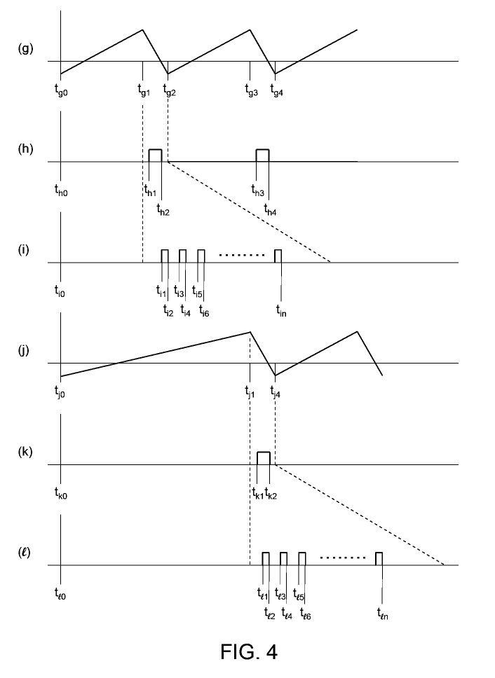

The timing and operation of cell 300 will be described in conjunction with the timing diagrams shown in FIG. 4. Time lines (g), (h) and (i) in FIG. 4 show the relationship for one frame rate while timelines (j), (k) and (l) show the same relationship for a second frame rate. Time line (g) shows the vertical synchronization signal for one frame rate. From time t_{g0} to t_{g1} the video system is active and collecting light to form the image. From time t_{g1} to t_{g2} the video system is inactive. This time period is the vertical blanking period previously described at which point the video capture system has completed capturing an image. The frequency of the vertical synchronization signal in (g) is the reciprocal of the time between t_{g0} and t_{g2}.

The charges collected by photodiodes 305 are transferred to amplifying transistors 315 when the read line 330 is asserted via the pulse shown in time line (h) between times tₕ₁ and tₕ₂. This pulse is not transmitted until the beginning of the vertical blanking period at time t_{g1}. Once the read transistors 310 have been turned on by the pulse applied on line 330, the amplifying transistors are “ready” to amplify the electrical signals.

Many cells 300 share output line 350. Each cell 300 outputs its signal onto line 350 when the associated address line 340 is asserted. The plurality of address pulses are shown in time line (i). The scale for time line (i) has been expanded to show the plurality of pulses that occur during a read pulse asserted on line 330. After all of the cells 300 have outputted their data onto line 350, the array of cells is reset by asserting a pulse on lines 325.

Time lines (j)-(k) show the same process but for a different frame rate. Like time line (g), an image is captured between times tⱼ₀ and tⱼ₁. After the image is captured, the first clock signal pulses between times tₖ₁ and tₖ₂ in time line (k). This pulse turns on the respective read transistors 310. While read transistor 310 is on, the various address transistors are turned on in succession using the pulses shown in time line (l) (one pulse for each row of cells 300). Again, the scale for time line (l) is expanded relative to time lines (j) and (k).

Like the CCD example described in conjunction with FIGS. 1 and 2, a slower vertical synchronization signal (i.e., lower frequency) correlates to a lower frame rate. This means a slower vertical synchronization signal has a longer period, which in turn means a longer time to capture an image. This is shown in FIG. 4 where the time between t_{g0} and t_{g1} is shorter than the time between tⱼ₀ and tⱼ₁. As a consequence the read pulse between tₖ₁ and tₖ₂ occurs later in time than the read pulse between tₕ₁ and tₕ₂. This in turn gives the CMOS image sensor more time to capture the light to form the image.

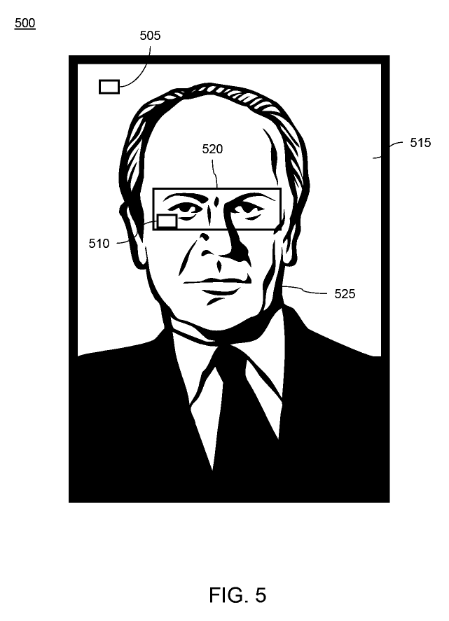

FIG. 5 is a diagram of a multi-region image pick-up device 500. Image pick-up device contains either CCD or CMOS cells 505 or 510, or a combination of both, as previously described. The cells in image pick-up device 500 are arranged into two different regions 515 and 520. The cells in region 515 are clocked at a different frequency than the cells in region 520. Multi-region image pick-up device 500 may also include other structures like a second array similar to array 150 in FIG. 1, an opaque film similar to opaque film 155 in FIG. 1, a storage element similar to storage element 114 in FIG. 1 and a shift register similar to shift register 160 in FIG. 1.

The operation of multi-region image pick-up device 500 allows for two regions of the image to be clocked at different rates. In other words, region 515 has a different region rate than region 520. As an example, region 515 is clocked as shown in FIG. 2, time lines (a)-(c) or FIG. 4, time lines (g)-(i), while region 520 is clocked as shown in FIG. 2, time lines (d)-(f) or FIG. 4, time lines (j)-(l).

The advantages of this system can be described with reference to video telephones. However, it should be understood that theses systems and methods may be employed in any type of video device. A human head 525 is superimposed over the multi-region image pick-up device 500 for illustrative purposes. Region 520 collects image data surrounding the eyes while region 515 collects image data over the remaining part of the head. As described earlier, the eyes are particularly prone to distortion, especially in low light conditions. By clocking the cells in region 520 slower, the cells can absorb more light and provide greater details about the subject's eyes. In contrast, the details of the remaining features are not as susceptible to distortion in low-light conditions and can be clocked at a higher rate to produce smoother motion on playback. Thus, region 520 is clocked at a different region rate than region 515.

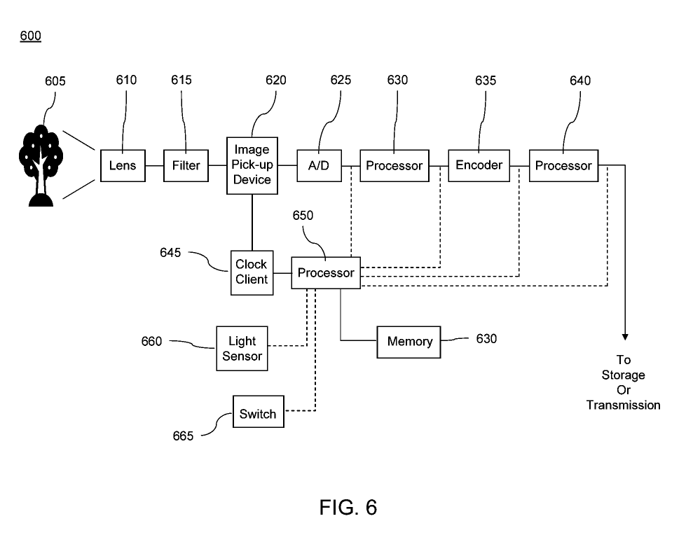

FIG. 6 is a diagram of an exemplary video camera system 600. An image of object 605 is to be captured. Lens 610 focuses the light reflecting from object 605 through one or more filters 615. Filters 615 remove unwanted characteristics of the light. Alternatively, multiple filters 615 may be used in color imaging. The filtered light is then shown upon image pick-up device 620. In one exemplary image pick-up device the light is shown upon array 110 of CCD 100, a CMOS image sensor or a multi-region image pick-up device 500 as previously described. The charges associated with each individual pixel are then sent to analog-to-digital (A/D) converter 625. A/D converter 625 generates digitized pixel data from the analog pixel data received from image pick-up device 620. The digitized pixel data is then forwarded to precessor 630. Processor 630 performs operations such as white balancing, color correction or may break the data into luminance and chrominance data. The output of processor 630 is enhanced digital pixel data. The enhanced digital pixel data is then encoded in encoder 635. As an example, encoder 635 may perform a discrete cosine transform (DCT) on the enhanced digital pixel data to produce luminance and chrominance coefficients. These coefficients are forwarded to processor 640. Processor 640 may perform such functions as normalization and/or compression of the received data. The output of processor 640 is then forwarded to either a recording system that records the data on a medium such as an optical disc, RAM or ROM or to a transmission system for broadcast, multicast or unicast over a network such as a cable, telephone or satellite network (not shown).

As noted earlier, image pick-up device 620 outputs its analog pixel data in response to various clock signals. These clock signals are provided by clock circuit 645. Clock circuit 645 varies the frequencies of one or more clock signals in response from a control signal issued by processor 650. For the multi-region image pick-up device 500, clock circuit 645 varies the frequencies for two sets of clock signals. One set for region 515 and the other set for region 520. In another implementation, clock circuit 645 varies the frequencies for the clock signals supplied to region 520 while maintaining the frequencies of the clock signals supplied to region 515 at constant rates.

Clock circuit 645 may generate its own reference clock signal (for example via a ring oscillator) or it may receive a reference clock from another source and generate the required clock signals using a phase-locked loop (PLL) or it may contain a combination of both a clock generation circuit (e.g., ring oscillator) and clock manipulation circuit (e.g., PLL). Processor 650 receives data from memory 655. Memory 655 stores basis data. This basis data is used in conjunction with another signal or signals generated by the video system 600 to determine if the frame rate and associated clock signals need adjustment. In one exemplary system, the basis data is threshold data that is compared with another signal or signals generated by the video system 600.

Processor 650 receives one or more inputs from sources in video system 600. These sources include the output of A/D converter 625, processor 630, encoder 635 and processor 640. These exemplary inputs to processor 650 are shown in FIG. 6 as dashed lines because any one or more of these connections may be made depending on the choices made by a manufacturer in designing and building a video system. These signals may also form part of the automatic control of the video system 600. In these systems, processor 650 outputs control signals (not shown) to image pick-up device 620, A/D converter 625, processor 630, encoder 635 and/or processor 640. These output control signals from processor 650 may be part of an automatic gain control (AGC), automatic luminance control (ALC) or auto-shutter control (ASC) sub-system.

As described earlier, A/D converter 625 converts the analog pixel data received from image pick-up device 620 to digitized pixel data. The output of A/D converter 625 may be, for example, one eight-bit word for each pixel. Processor 650 can compare the magnitude of these eight-bit words to threshold data from memory 655 to determine the brightness of each region of the images being captured. If one region, say region 520, of the images is not bright enough, the eight-bit words will have small values and processor 650 will issue a control signal to clock circuit 645 instructing it to decrease the frequency of the frame rate and a first set of clock signals (see time lines (b), (c), (e) and (f) in FIG. 2 and time lines (h), (i), (k) and (l) in FIG. 4) for that region. Similarly, if region 520 is too bright, the eight bit words will have large values and processor 650 will issue a different control signal to clock circuit 645 instructing it to increase the frequency of the first set of clock signals.

In one exemplary implementation of video system 600, region 515 of image pick-up device 620 is controlled in the same way as region 520. That is, region 520 transmits data to A/D converter 625 that in turn generates output words. These words are compared against threshold data from memory 655 by processor 650. Processor 650 then instructs clock circuit 645 to adjust the frequencies of the second set of clock signal supplied to region 520. However, processor 650 uses different threshold data from memory 655 in the comparison associated with region 515 than the threshold data associated with region 520. The result is clock circuit 645 varies the second set of clock signals output to region 520 in a different way (increasing or decreasing) and/or in a different magnitude than the first set of clock signals supplied to region 515. Thus regions 515 and 520 may have different region rates.

In another exemplary implementation of video system 600, region 515 of image pick-up device 620 is controlled via a constant set of clock signals. While the region rate for region 520 may increase or decrease, the region rate for region 515 remains the same.

Processor 630 receives the words output by A/D converter and generates enhanced digital pixel data as previously described. Instead of, or in addition to, processor 650 receiving code words from regions 515 (optionally) and 520 via A/D converter 625, processor 650 receives the enhanced digital pixel data from processor 630 and compares that to threshold data received from memory 655.

Encoder 635 generates a signal in the frequency domain from the data received from processor 630. More specifically, encoder 635 generates transform coefficients for both the luminance and chrominance values received from processor 630. In one implementation, processor 650 receives the luminance coefficients, instead of or in addition to the outputs from either or both A/D converter 625 and processor 630, and compare those values to the threshold data received from memory 655 for region 520 and optionally for region 515.

Processor 640 may normalize and compress the signals received from encoder 635. This normalized and compressed data may be transmitted to processor 650 where it is denormalized and decompressed. The subsequent data is then compared against the threshold data stored in memory 655 for each region. Again, the output form processor 640 may be used instead of the outputs from A/D converter 625, processor 630, encoder 635 or in any combination thereof in generating the control signal or signals output to clock circuit 645.

Processor 650 may also receive signals from light sensor 660. Light sensor 660 measures the ambient light in the area and sends a data signal representative of that measurement to processor 650. Processor 650 compares this signal against threshold data received from memory 655 and adjusts the clock signals to region 520 (and optionally the clock signals to region 515) via clock control circuit 645 accordingly. If the ambient light is low, processor 650 will determine this from its comparison using threshold data from memory 655 and issue a control signal to clock circuit 645 instructing it to reduce the frame rate. In this exemplary implementation, the light sensor outputs only a single value representative of ambient light for the entire frame. Processor 650 receives two sets of threshold data, one for region 520 and one for region 515, and compares them against the output of light sensor 650 to produce two control signals. These control signals are then forwarded to clock circuit 645 to adjust the clock signals applied to regions 515 and 520.

Processor 650 may also receive a signal from manual brightness control switch 665. Manual switch 665 is mounted on the external housing (not shown) of video system 600. The user of video system 600 may then adjust manual switch 665 to change the region rates and frequencies of some of clock signals of video system 600. In one exemplary system, the turning of manual switch 665 causes processor 650 to retrieve different threshold data from memory 655. Thus the results of the comparisons performed by processor 650 using data from A/D converter 625, processor 630, encoder 635 or processor 640 associated with region 520 (and optionally region 515) change by using different threshold data from memory 655.

In one example, manual switch 665 is a dial connected to a potentiometer or rheostat by which the resistance is changed when the dial is turned. The change in resistance is then correlated to a change in one or more region rates. It should be understood that both light sensor 660 and manual switch 665 either include integrated A/D converters or A/D converters must be inserted between light sensor 660 and processor 650 and manual switch 665 and processor 650. Alternatively, processor 650 may also include integrated A/D converters for the signals received from light sensor 660 and manual switch 665.

It should also be noted that the outputs from light sensor 660 and manual switch 655 may be used in combination with or without any of the outputs from A/D converter 625, processor 630, encoder 635 and processor 640.

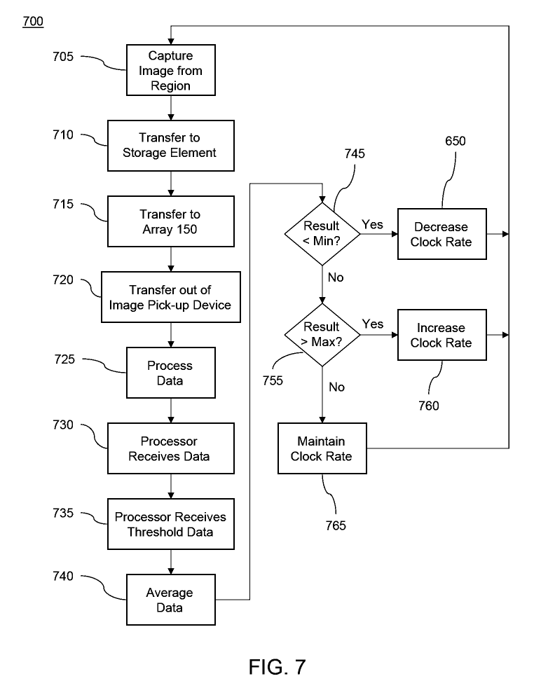

FIG. 7 is a flow chart 700 showing the operation of a video system such as the one shown in FIG. 6. At step 705 at least one region of an image is captured in the multi-image pick-up device 500. At 30 frames per second, each cell within that region will receive light for 30.66 msec. At step 710 the charges accumulated in elements 112 are transferred to storage elements 114. (This is assuming that multi-region image pick-up device is structurally similar to array 100 in FIG. 1. If multi-region image pick-up device 500 does not have storage elements, this step can be omitted.) Referring to FIG. 2, this is shown in timelines (b) and (e). For the cell 300 shown in FIG. 3, step 710 correlates to turning on read transistor 310. This may occur during a portion of the vertical blanking interval.

At step 715 the charges in storage elements 114 are transferred to storage array 150 of CCD 100 if multi-region pick-up device 500 is configured similarly to FIG. 1. For an image pick-up device 500 having cells configured as shown in FIG. 3, step 715 correlates to pulsing the address lines 340 so as to turn on and off address transistors 320 and thereby provide the electrical signal onto output lines 350. This also may occur during the vertical blanking interval as shown in timelines (c) and (f) of FIG. 2 or timelines (i) and (l) of FIG. 4.

At step 720, the charges stored in array 150 are transferred out of CCD 100 or CMOS image sensor via register 160. This occurs during the horizontal blanking interval.

At step 725 the region of image data captured by image pick-up device 620 is processed to form representative data of the image. Depending on the construction of the video system, this processing could use any combination of A/D converter 625, processor 630, encoder 635 and processor 640.

At step 730, processor 650 receives representative data of the region data captured by image pick-up device 620. In FIG. 6, this representative data may come from A/D converter 625, processor 630, encoder 635 or processor 640. Processor 650 may receive this representative data from one or more of these devices. In addition, processor 650 may also receive data from light sensor 660 and/or manual switch 665. At step 735, processor 650 retrieves threshold data from memory 655.

At step 740, processor 650 averages the representative data from a single frame. This averaging compensates for intentional light or dark spots in the region. An example of this is if the image being captured is of a person wearing a black shirt. The pixels associated with the black shirt will have low luminance values associated with it. However the existence of several low luminance values is not an indication of a low-light condition requiring a change in the region rate in this example. By averaging many pixel luminance values, or equivalent data, across the entire region, or across multiple regions from multiple frames, intended dark spots can be compensated for by lighter spots such as a white wall directly behind the person being imaged. Similarly, the existence of several high luminance values, or their equivalents, of an image of a person wearing a white shirt would not indicate a high-light condition requiring a change in the region rate.

After the processor 650 has determined a composite luminance value for the region, it compares that value to a minimum threshold data retrieved from memory 655 at step 745. If the composite luminance value is below a minimum threshold value, processor 650 issues a control signal at step 750 instructing clock circuit 645 to slow down certain clock signals it generates. In this example, clock circuit 645 slows down the region rate from time line (a) to time line (d) (or time line (g) to (j)) and slows down the frequencies of the first clock signal from timeline (b) to (e) (or time line (h) to (k)) in FIGS. 2 and 4, respectively. The process then proceeds to capture another region of an image at step 705.

If at step 745 the composite luminance values are above or equal to the minimum threshold data, processor 650 compares the composite luminance values to a maximum threshold data at step 755. If the composite luminance value is above this maximum threshold value, processor 650 issues a control signal at step 760 instructing clock circuit 645 to speed-up certain clock signals(e.g., the vertical synchronization signal and the first clock signal) it generates. If the composite luminance values are equal to or between the minimum and maximum threshold values, the clock signals generated by clock circuit 645 are maintained at their current rates at step 765. The process then continues at step 705 where the next region of an image is captured.

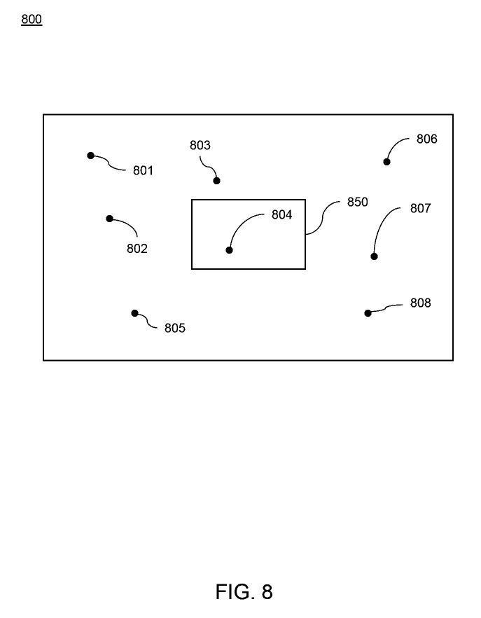

FIG. 8 shows a region 800. From region 800, two subsets of pixel data are shown. In the example shown in FIG. 8, a subset of pixel data is selected at random from across the entire region 801-808. The luminance values of these pixels 801-808 are averaged by processor 650 in step 740 of FIG. 7. It should be noted that other exemplary systems may use a different number of pixel data such as 16, 32, 64 etc. As described previously, this averaging compensates for desired differences in the region such as black shirts and white walls.

The second subset is shown as rectangle 850 in frame 800. Every luminance value for every pixel within rectangle 850 is averaged in step 740 in FIG. 7. It should be noted that other exemplary systems may use different shapes (e.g., circle, square, triangle, etc) and may use two or more subsets of pixel data defined by shapes. In addition, the shapes used to define the subset do not necessarily have to be centered in the region as shown in FIG. 8.

In yet a third exemplary system, the video system may use all of the luminance values from all of the pixels in the region to generate the average calculated in step 740 of FIG. 7.

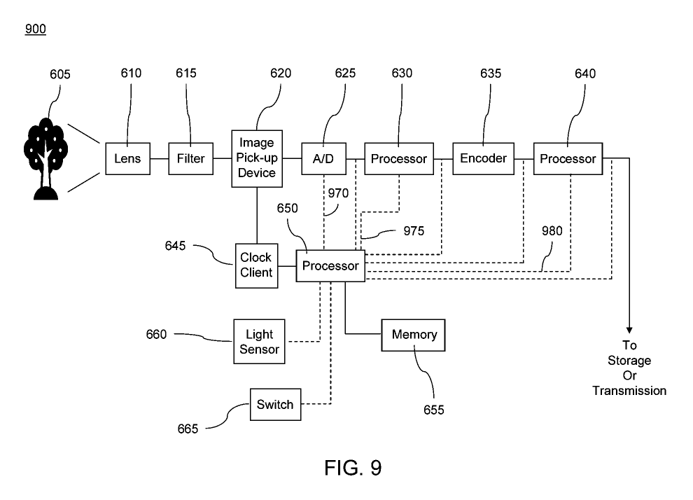

FIG. 9 shows another video capture system 900. This system is similar to video system 600 shown in FIG. 6 so a detailed explanation of every element in FIG. 9 will not be provided. Also, reference numbers used in FIG. 9 designate similar structures in FIG. 6. Video system 900 differs from video system 600 in that video system 900 has optional control signals 970 and 975 output from processor 650 to A/D converter 625 and processor 630. These are gain adjustment signals. These gain signals may be necessary if processor 650 instructs clock circuit 645 to reduce the region rate and corresponding clock signals to a point where other aspects of the image quality are jeopardized. For example, if the region rate is too low, the person viewing the images will notice the gaps or vertical blanking intervals between the regions of the frames. When this happens, the viewer notices a flicker in the images. When this occurs, processor 650 issues control signals 970 and 975 to increase the gain in either A/D converter 625 or processor 630 in conjunction with an increase in the region rate. Increasing the gain in either of these devices will assist video system 900 in compensating for low-light conditions at higher region rates.

Video system 900 also shows another control signal 980. Control signal 980 is output from processor 650 to processor 640. Control signal 980 is used to compensate for the automatic changes made in the region rates so that the playback by another video processing system or receiver is correct.

In one implementation, control signal 980 instructs processor 640 to copy existing regions of frames until a desired region rate is reached. As an example, assume video system 900 begins capturing regions at 30 frames/sec. Sometime later, the ambient light is reduced and video system 900 compensates by reducing the region rate to a select region rate of 24 frames/sec. Control signal 980 instructs processor 540 to make copies of actual captured regions. In one example, control signal 980 instructs processor 640 to duplicate every fourth region as the next region in the series so that the number of regions output by processor 640 is 30 per second even though the rate at which processor 640 receives frame data from encoder 635 is 24 regions per second. In a 30 region run, processor 640 creates the 5^{th}, 10^{th}, 15^{th}, 20^{th}, 25^{th} and 30^{th} regions by copying the 4^{th}, 8^{th}, 12^{th}, 16^{th}, 20^{th} and 24^{th} captured regions, respectively. In this way video system 900 always outputs 30 regions/sec and the receiver or playback device can be designed to expect 30 regions/sec.

Alternatively, control signal 980 may instruct processor 640 to interpolate new regions from captured regions. Using the select region rate of 24 regions per second and 30 regions per second example above, processor 640 interpolates the 5^{th}, 10^{th}, 15^{th}, 20^{th}, 25^{th} and 30^{th} regions from the following captured region pairs, respectively: 4^{th} and 5^{th}, 8^{th} and 9^{th}, 12^{th} and 13^{th}, 16^{th} and 17^{th}, 20^{th} and 21^{st} and 24^{th} and 1^{st} (from the next group). Again, the receiver or playback video system can then be designed to expect to receive 30 regions/sec.

In yet another alternative system, control signal 980 instructs processor 640 to put a control word in the data so that the receiver or playback device can either copy regions or interpolate regions as previously described. In this example, the video display system continually reads these control words as the regions are displayed to the user. If the control word changes, the video display device compensates accordingly by creating additional regions as previously described.

Referring back to FIG. 5, a border may be perceivable by the user between adjacent cells in region 515 and region 520. This border may be perceived by the user during playback if region 515 is displayed at a different rate than region 520. This occurs if extra regions are not created as previously described to ensure that each region 515 and 520 is played back at the same rate. When region 515 is displayed at a different rate than region 520, display device can interpolate and average or smooth the pixels around the border between regions 515 and 520. This will prevent the border from being displayed so that user can perceive it.

It should also be noted that this technique of interpolating or smoothing the pixels near the “border” can be done with interpolated regions. That is, if region 520 is created at 24 regions/sec but has additional regions put into its stream via processor 640 as previously described to create a data flow that includes 30 regions/sec, and region 515 is created at 30 regions/sec, a perceptible border may still be seen by the user during display. To compensate for this, the display device can interpolate or smooth the pixels in regions 515 and 520 that are near the border to reduce any discontinuity the viewer may see between the two regions.

FIG. 10 shows an exemplary video display system with multiple regions of display. A video signal is received either over a network or from a storage medium by processor 1005. Processor 1005 may perform such operations such as decrypting or possibly tuning the received video signals. Processor 1005 outputs the data to decoder 1010. Decoder 1010 reverses the encoding process previously described in conjunction with encoder 635. D/A converter 1015 receives the decoded data from decoder 1010 and converts it into analog data. Display device 1020 receives the analog output from D/A converter 1015 and uses it to display an image for the user to watch. Processor 1005, decoder 1010, D/A converter 1015 and display 1020 receive control signals

The above systems and methods may have different structures and processes. For example, processors 630, 640 and 650 may be general purpose processors. These general purpose processors may then perform specific functions by following specific instructions downloaded into these processors. Alternatively, these processors may be specific processors in which the instructions are either hardwired or stored in firmware coupled to the processors. It should also be understood that these processors may have access to storage such as memory 655 or other storage devices or computer-readable media for storing instructions, data or both to assist in their operations. These instruction will cause these processors to operate in a manner substantially similar to the flow chart shown in FIG. 7. It should also be understood that these elements, as well as the A/D converter 625 may receive additional clock signals not described herewith.

Another variation for the systems shown in FIGS. 6 and 9 is the integration of various components into one component. For example, in FIGS. 6 and 9, processor 630, encoder 635, processor 640 and processor 650 may all be incorporated into one general purpose processor or ASIC. Similarly, the individual steps shown in FIG. 7 may be incorporated together into fewer steps or further divided out into sub-steps or some steps may be omitted. Finally, the organization of FIGS. 6 and 9 as well the order of the steps of FIG. 7 may be altered by one of ordinary skill in the art.

There are other alternatives in obtaining data used in determining to increase or decrease the region rate. For example, the video system 900 shown in FIG. 9 includes automatic gain control signals 970 and 975. Instead of processor 650 determining to change the frame rate based upon comparing the luminance values of pixel data (as previously described), processor 650 may change the properties of the AGC signals 870 or 875 that in turn change the region rate. In this system, the AGC signals 870 and 875 will increase for decreasing light levels up to a point. Once that point is reached, the region rate is adjusted and the AGC signals 870 or 875 can be decreased so as to increase the SNR as previously described. If the light level continues to decrease, the AGC signals 870 and 875 will again increase to a point. At this second point, the region rate is reduced again and the AGC signals 870 and 875 are again increased. It follows that the reverse process occurs for increasing light conditions. It should also be noted that other automatic control signals such as automatic luminance control (ALC) and auto-shutter control (ASC) may be output by processor 650.

In yet another system, luminance values are averaged across multiple regions. In this system, the overall luminance values of a region or part of a region are determined and compared for a plurality of regions from a plurality of frames instead of on a region-by-region basis.

The above systems and methods were described using threshold data and comparing that to a signal generated by the video processing system 600 or 900. The basis data could also instead by a correction curve or proportionality constant against which the data from the video processing system 600 or 900 is compared. Processor 650 compares the data output from a component of the system, A/D converter 625 for example, against the correction curve and generates the output control signal to clock circuit 645 based upon the proportionality of the A/D converter output data compared to the correction curve. In yet another system, processor 650 may input the data it receives from the video system, output of encoder 635 for example, into a function, which is the basis data, and use the result of the function to adjust the region rate of the system via the control signal.

The above systems and methods have been described using a 1-to-1 correspondence between the region rate and the first clock signal. Alternative relationships are also permissible. An example of such an alternative occurs in color imaging using a single image pick-up device. In this example, filer 615 also includes several color filters. For each desired color to be captured in the image, one color filter from filter 615 is placed between the lens 610 and image pick-up device 620 during the active phase of the vertical synchronization signal. In this exemplary system, the pulses shown in time lines (b), (c), (e) and (f) of FIG. 2 and time lines (h), (i), (k) and (l) would occur during the active phase of the vertical synchronization signal (i.e., between tₐ₀ and tₐ₁, t_{d0} and t_{d1}, t_{g0} and t_{g1}, and tⱼ₀ and tⱼ₁ and each set would be generated once for each color filter). This means that the onset of the pulses shown in timelines (b), (c), (e) and (f) and (h), (i), (k) and (l) need not wait until the vertical blanking period begins at times tₐ₁, t_{d1}, t_{g1} and tⱼ₁ Instead these pulses may be initiated at some proportion, say ⅓ for example, of either the entire vertical synchronization signal or the active phase of the vertical synchronization signal. It should also be noted that the clock signals supplied to image pick-up device 620 need not be related to a vertical blanking interval.

The process shown in FIG. 7 may be implemented in a general, multi-purpose or single purpose processor. Such a processor will execute instructions, either at the assembly, compiled or machine-level, to perform that process. Those instructions can be written by one of ordinary skill in the art following the description of FIG. 7 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

Other alternative structures are also possible. For example, while FIG. 5 shows region 520 circumscribed by region 515 so that they share four border lines. In alternative structures, region 520 could be made larger so that it extends to the very top of the image. In this structure, modified region 520 would only share three border lines with region 515. In yet another structure, the entire image is divided into two regions by a single border line (e.g., the image is cut in half by a horizontal border spanning the entire image).

Finally, while the above systems and methods were described using full region data, it should be understood that interleaved data may be captured and processed in like fashion for each region.

1. A video device comprising:
an image pick-up device comprised of a first region and a second region wherein the first region captures a first portion of image data and converts that first portion of image data into first electrical signals wherein the first electrical signals are transferred in response to a first clock signal and the second region captures a second portion of image data and converts that second portion of image data into second electrical signals wherein the second electrical signals are transferred in response to a second clock signal;
a clock circuit that generates the first and second clock signals wherein a frequency of the first clock signal is proportional to a first region rate and a frequency of the second clock signal is proportional to a second region rate and the clock circuit varies the frequency of the first clock signal in response to a first control signal; and
a first processor that receives first data and basis data and generates the first control signal wherein the first control signal is based upon a calculation using the first data and the basis data.

2. The video device of claim 1 further comprising:
an A/D converter coupled to the image pick-up device so as to receive the first electrical signals from the image pick-up device and converts the first electrical signals into second data wherein the first data is a sub-set of the second data.

3. The video device of claim 1 further comprising:
an A/D converter coupled to the image pick-up device so as to receive the first electrical signals from the image pick-up device and converts the first electrical signals into second data; and
a second processor coupled to the A/D converter so as to receive the second data from the A/D converter and manipulate the second data into third data wherein the first data is a sub-set of the third data.

4. The video device of claim 1 further comprising:
an A/D converter coupled to the image pick-up device so as to receive the first electrical signals from the image pick-up device and converts the first electrical signals into second data;
a second processor coupled to the A/D converter so as to receive the second data from the A/D converter and manipulate the second data into third data; and
an encoder coupled to the second processor so as to receive the third data from the second processor and encode the third data into fourth data wherein the first data is a sub-set of the fourth data.

5. The video device of claim 1 further comprising:
an A/D converter coupled to the image pick-up device so as to receive the first electrical signals from the image pick-up device and converts the first electrical signals into second data;
a second processor coupled to the A/D converter so as to receive the second data from the A/D converter and manipulate the second data into third data;
an encoder coupled to the second processor so as to receive the third data from the second processor and encode the third data into fourth data; and
a third processor coupled to the encoder so as to receive the fourth data from the encoder and manipulate the fourth data into fifth data wherein the first data is a sub-set of the fifth data.

6. The video device of claim 1 further wherein the basis data is threshold data and the device further comprises:
a switch coupled to the first processor that instructs the processor to retrieve the threshold data from one of a plurality of threshold data.

7. The video device of claim 1 further comprising:
a light sensor coupled to the first processor that measures a level of light and generates the first data based upon the measure of the level of light.

8. The video device of claim 3 wherein the sub-set of the third data includes all of the third data.

9. The video device of claim 1 wherein the basis data is a correction curve and the calculation determines the proportionality between the first data and the correction curve.

10. The video device of claim 1 wherein the basis data is threshold data and the calculation is a comparison between the first data and the threshold data.

11. The video device of claim 5 wherein the first processor is coupled to the third processor so as to output a second control signal to the third processor wherein the third processor compensates for a difference between the first region rate and the second region rate based on the second control signal.

12. The video device of claim 11 wherein the third processor compensates for the difference between the first region rate and the second region rate by copying the fourth data.

13. The video device of claim 11 wherein the third processor compensates for the difference between the first region rate and the second region rate by interpolating at least some of the fourth data into sixth data and together the fourth and sixth data are manipulated into the fifth data.

14. The video device of claim 11 wherein the third processor compensates for the difference between first region rate and the second region rate by sending a control signal with the fifth data indicating the difference between the first region rate and the second region rate.

15. The video device of claim 2 wherein the first processor is coupled to the A/D converter so as to output a second control signal to the A/D converter wherein the A/D converter changes its gain in response to the second control signal.

16. The video device of claim 3 wherein the first processor is coupled to the second processor so as to output a second control signal to the second processor wherein the second processor changes its gain in response to the second control signal.

17. The video device of claim 1 wherein the first data is used in the generation of an automatic control signal.

18. The video device of claim 3 wherein the sub-set of the third data includes data from a plurality different times.

19. The video device of claim 1 wherein the first region is circumscribed by the second region.

20. A computer-readable medium wherein the computer-readable medium comprises instructions for controlling a processor to perform a method comprising:
transferring first data generated by a first region of an image pick-up device at a first clock rate proportional to a first frame rate wherein the first clock rate varies in response to a control signal issued by the processor;
transferring second data generated by a second region of the image pick-up device at a second clock rate proportional to a second frame rate;
generating third data from the first data;
comparing the third data to a threshold data so as to produce a resultant data; and
changing the control signal issued by the processor so as to adjust the first clock rate in response to the resultant data.

21. The computer-readable medium of claim 20 wherein the instructions for generating second data further comprise averaging a value from a subset of the first data.

22. The computer-readable medium of claim 20 wherein the instructions for comparing the second data to the threshold data further comprise comparing a magnitude of the second data against a minimum threshold value.

23. The computer-readable medium of claim 22 wherein the instructions for changing the first clock rate further comprises issuing the control signal so as to decrease the first clock rate when the comparing determines that the magnitude of the second data is lower than the minimum threshold data.

24. The computer-readable medium of claim 20 wherein the instructions for comparing the second data to the threshold data further comprise comparing a magnitude of the second data against a maximum threshold value.

25. The method of claim 24 wherein the instructions for changing the first clock rate further comprise increasing the first clock rate when the comparing determines that the magnitude of the second data is higher than the maximum threshold data.
